(19) United States
(12) Patent Application Publication
(10) Pub. No.: US 2011/0289677 A1
(43) Pub. Date: Dec. 1, 2011

(54) Auxiliary Moving Device

(76) Inventor: Miao-Yuan Huang, Xizhi City (TW)

(21) Appl. No.: 12/791,201

(22) Filed: Jun. 1, 2010

(51) Int. Cl. A61G 7/10

(52) U.S. Cl. 5/81.1 R

(57) ABSTRACT

An auxiliary moving device contains a first cushion; two support members disposed on two sides of the first cushion, and the first cushion allowing to move on the support members, one of the support members including a plurality of holes; a positioning mechanism fixed on the first cushion and including a post, the first cushion being inserted into one of the holes of the post of the positioning mechanism to fix the support member.

### BACKGROUND OF THE INVENTION

1. Field of the Invention

The present invention relates to an auxiliary moving device, and more particularly to an auxiliary moving device that includes a positioning mechanism.

2. Description of the Prior Art

A disable person has to be cared by a caregiver in daily life to get up, move, eat, have rehabilitation treatment or a bath, etc.

Taking a bath for example, the caregiver has to assist the disable person to move toward a bath room, and then make the disable person sit on an auxiliary chair 1 as shown in FIG. 1 to have a bath or other motions. However, because a seat is locked on legs of the auxiliary chair 1 during the bath or the motions, it is dangerous and difficult to move the disable person.

The present invention has arisen to mitigate and/or obviate the afore-described disadvantages.

### SUMMARY OF THE INVENTION

The primary object of the present invention is to provide an auxiliary moving device that can help a disable person move in daily life.

Another object of the present invention is to provide an auxiliary moving device that the disable person can sit on the auxiliary moving device to move comfortably and safely.

To obtain the above objectives, an auxiliary moving device provided by the present invention a first cushion;

two support members disposed on two sides of the first cushion, and the first cushion allowing to move on the support members, one of the support members including a plurality of holes;

a positioning mechanism fixed on the first cushion and including a post, the first cushion being inserted into one of the holes of the post of the positioning mechanism to fix the support member.

### BRIEF DESCRIPTION OF THE DRAWINGS

FIG. 1 is a perspective view of a conventional auxiliary moving device;

FIG. 2A is a perspective view showing the operation of an auxiliary moving device according to a first embodiment of the present invention;

FIG. 2B is a perspective view showing the exploded components of the auxiliary moving device according to the first embodiment of the present invention;

FIG. 2C is a bottom perspective view showing the assembly of the auxiliary moving device according to the first embodiment of the present invention;

FIG. 3A is a cross sectional view showing a part of a first cushion and a positioning mechanism of the auxiliary moving device according to the first embodiment of the present invention;

FIG. 3B is a cross sectional view showing a part of the operation of the positioning mechanism of the auxiliary moving device according to the first embodiment of the present invention;

FIG. 4A is a perspective view showing the exploded components of an auxiliary moving device according to a second embodiment of the present invention;

FIG. 4B is a bottom perspective view showing the exploded components of the auxiliary moving device according to the second embodiment of the present invention;

FIG. 5A is a perspective view showing the operation of an auxiliary moving device according to a third embodiment of the present invention;

FIG. 5B is a perspective view showing the exploded components of the auxiliary moving device according to the third embodiment of the present invention.

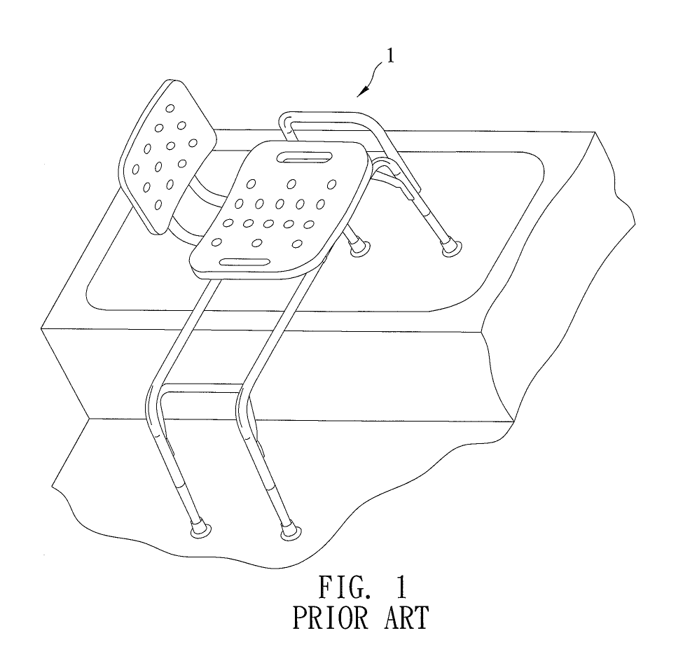

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

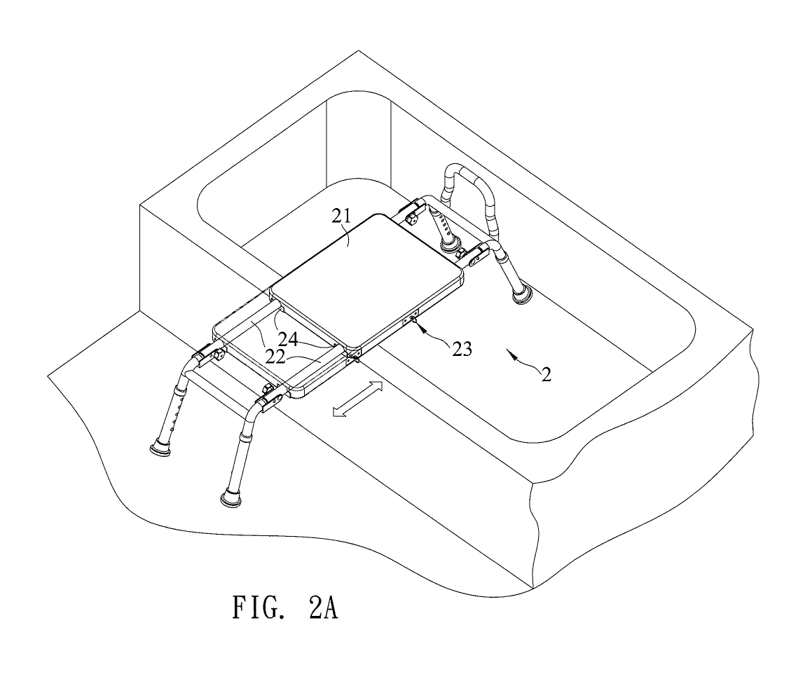

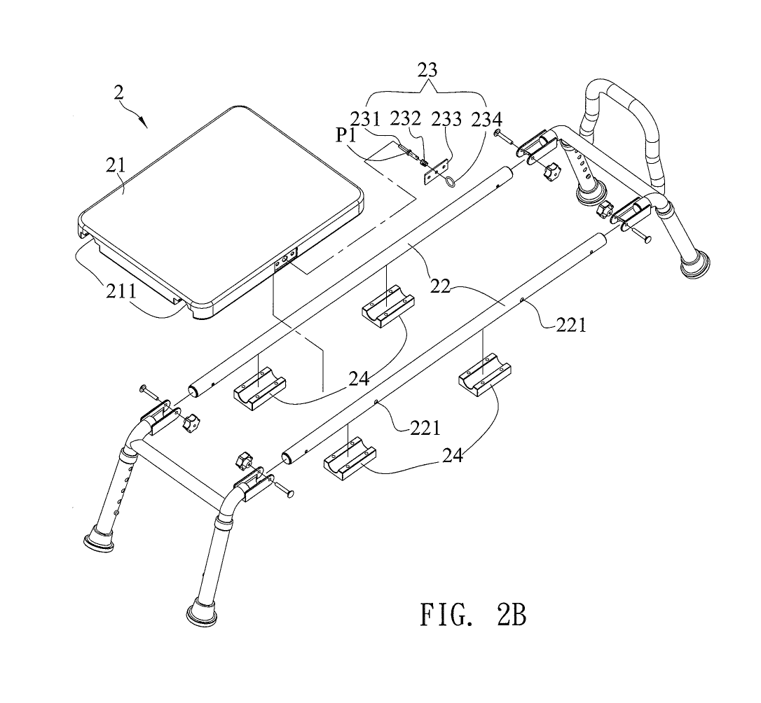

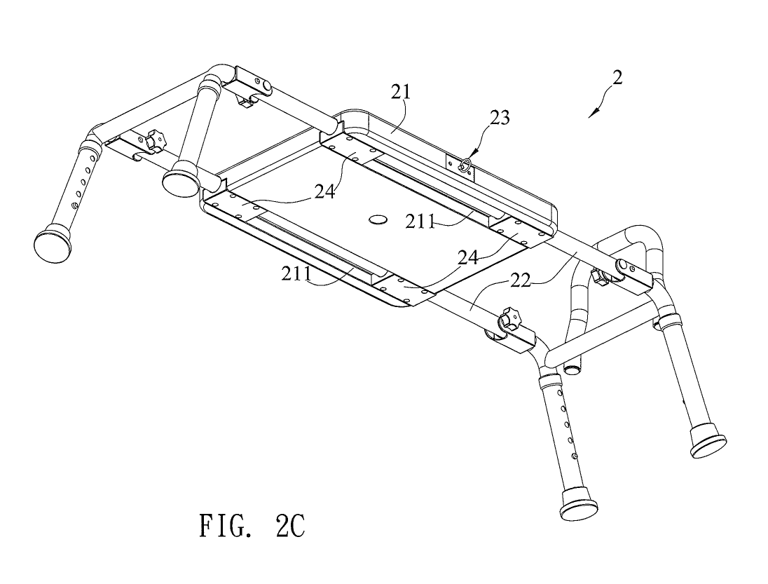

With reference to FIGS. 2A-2B, an auxiliary moving device 2 in accordance with a first embodiment of the present invention is used to help a disable person movement in daily life.

The auxiliary moving device 2 includes a first cushion 21, two support members 22, and a positioning mechanism 23.

The support members 22 are disposed on two sides of the first cushion 21, and the first cushion 21 allows moving on the support members 22. In this embodiment, the two support members 22 are located at the two sides of the first cushion 21, wherein the first cushion 21 includes two first grooves 211 located at two sides of a bottom end thereof respectively, and each support member 22 matches with the first groove 211.

In other words, to match the support member 22 with the first groove 211 of the first cushion 21, the first groove 211 is formed in a semi-arc shape to cooperate with the support member 22 with a circular cross section so that the first cushion 21 moves on the support member 22.

As shown in FIGS. 2B and 2C, to make the first cushion 21 moves on the support member 22, the auxiliary moving device 2 further includes a plurality of fixing elements 24 connected with the bottom end of the first cushion 21, wherein the support member 22 is retained between the fixing elements 24 and the first cushion 21. In this embodiment, the auxiliary moving device 2 includes four fixing elements 24 to be located at the two sides of the bottom end of the first cushion 21 so as to connect with the first cushion 21, and the support members 22 are inserted through connections of the first cushion 21 and the fixing elements 24 so that the first cushion 21 moves on the support members 22. Of course, a number and a position of the fixing element 24 are not limited in this embodiment, they are provided based on different requirements so that the fixing element 24 is connected with the first cushion 21, and the support member 22 moves in the first groove 211 of the first cushion 21.

To match with the support member 22 having the circular cross section, the fixing element 24 is provided with a second groove formed in a semi-arc shape to form a circular cross section with the first groove 211 of the first cushion 21 so that the support member 22 moves in the groove 211 of the first cushion 21.

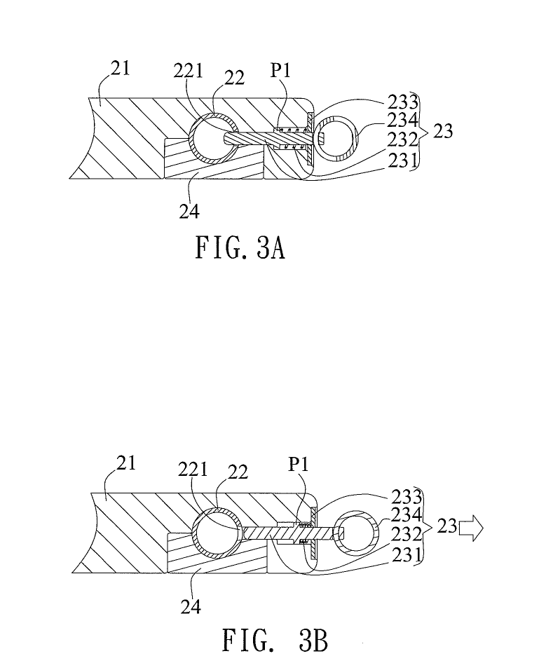

Referring to FIGS. 2B and 3A, the positioning mechanism 23 is fixed on the first cushion 21 and includes a post 231, and one of the support members 22 includes a plurality of holes 221, the first cushion 21 is inserted into one of the holes 221 of the post 231 of the positioning mechanism 23 to fix the support member 22, in other words, the positioning mechanism 23 is applied to fix the first cushion 21 on the support member 22.

In this embodiment, the support member 22 shown on a right side of FIG. 2B includes two holes 221, wherein the post 231 cooperates with the hole 221, in other words, a diameter of the hole 221 is larger than that of the post 231 so that the post 231 is inserted into the hole 221 to be positioned.

The positioning mechanism 23 further includes a spring 232, a stopping piece 233, and a pull ring 234, wherein the post 231 is inserted through the spring 232, and the post 231 includes a projection P1 so that the spring 232 is defined between the stopping piece 233 and the projection P1, and the pull ring 234 is coupled with the post 231. As shown in FIG. 3A and 3B, the positioning mechanism 23 is operated as follows.

As illustrated in FIG. 3B, when a caregiver pulls the pull ring 234 outward, the projection P1 of the post 231 moves close to the stopping ring 233 to press the spring 232 so that the spring 232 deforms, and the post 231 connected with the pull ring 234 moves away the hole 221 of the support member 22. In the meantime, the caregiver forces the first cushion 21 so that the first cushion 21 moves relative to the support member 22.

With reference to FIG. 3A, when the post 231 is response to another hole 221 of the support member 22, if the caregiver does not force the post 231, the post 231 is pushed by the spring 232 to insert into the another hole 221 so that the first cushion 21 is fixed to the support member 22 by using the post 231 of the positioning mechanism 23 and the hole 221 of the support member 22, hence the first cushion 21 is fixed on the support member 22 without moving by ways of the post 231 of the positioning mechanism 23.

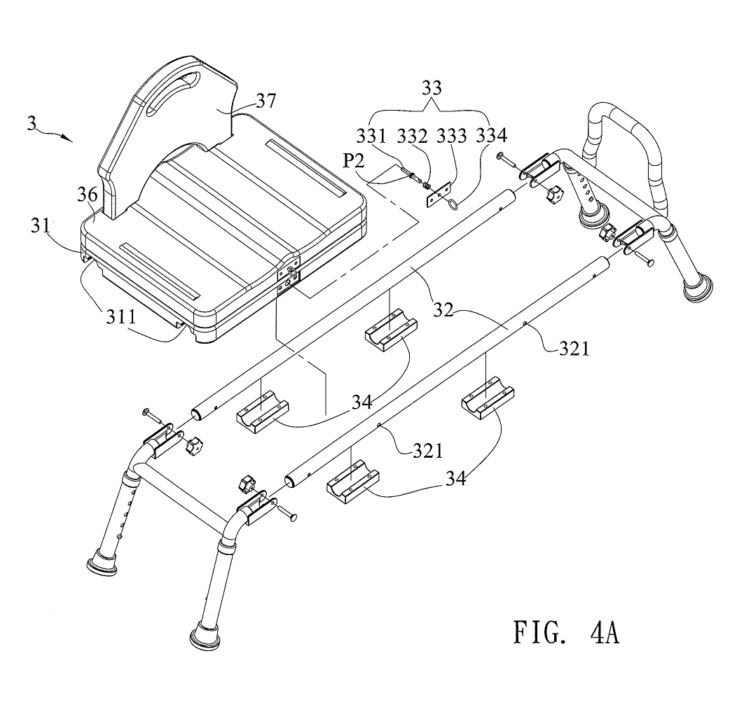

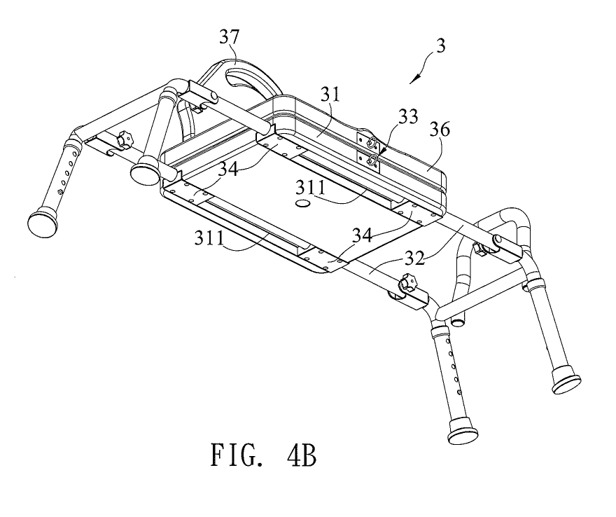

As shown in FIGS. 4A and 4B, a difference of an auxiliary moving device 3 according to a second embodiment of the present invention from the auxiliary moving device 2 of the second embodiment includes a second cushion 36 and a chair back 37, wherein the second cushion 36 is disposed on a first cushion 31 and connected with the first cushion 31, and the chair back 37 is fixed on one side of the second cushion 36 so that the disable person sits on the auxiliary moving device 3 to move comfortably and safely.

Because the other related components of the auxiliary moving device 3 are identical to those of the auxiliary moving device 2, further remarks are omitted.

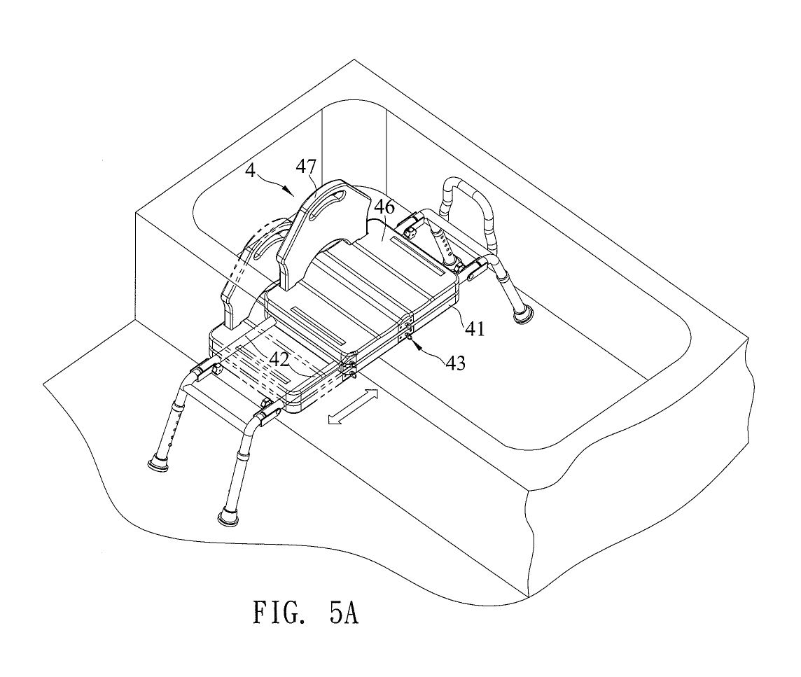

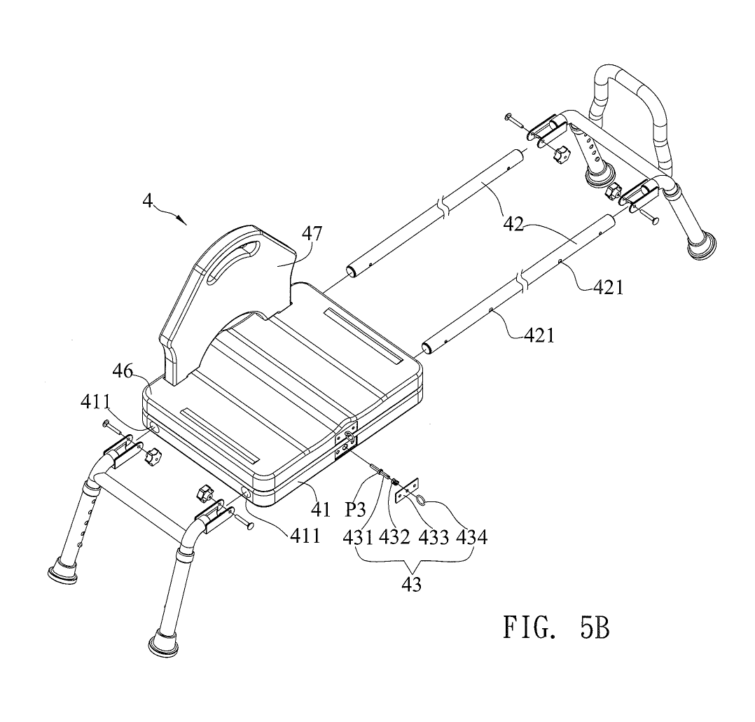

As illustrated in FIG. 5A and 5B, a difference of an auxiliary moving device 4 according to a third embodiment of the present invention from the auxiliary moving device 4 of the second embodiment includes a first cushion 41 having two orifices 411 which are located at two sides of a bottom end of the first cushion 41, and two support members 42 are fixed on the first cushion 41 by using the orifices 411. In other words, an inner diameter of the orifice 411 is larger than a diameter of a cross section of the support member 42 so that the support member 42 is inserted into the first cushion 41 through the orifice 411, and the first cushion 41 moves on the support member 42 securely.

Because the other related components of the auxiliary moving device 4 are identical to those of the auxiliary moving device 3, further remarks are omitted.

Thereby, the first cushion of the auxiliary moving device allows to move on the support members, and one of the support members includes a number of positioning holes, the positioning mechanism includes the post, the first cushion is inserted into one of the holes by using the post of the positioning mechanism to be fixed on the support member, hence the disable person sits on the first cushion is capable of moving on the support member easily. In addition, the post of the positioning mechanism is inserted into the hole of the support member so that the first cushion is fixed on the support member without moving, therefore the auxiliary moving device can help the disable person to move in daily life easily and safely.

While we have shown and described various embodiments in accordance with the present invention, it is clear to those skilled in the art that further embodiments may be made without departing from the scope of the present invention.

What is claimed:

1. An auxiliary moving device comprising:
a first cushion;
two support members disposed on two sides of the first cushion, and the first cushion allowing to move on the support members, one of the support members including a plurality of holes;
a positioning mechanism fixed on the first cushion and including a post, the first cushion being inserted into one of the holes of the post of the positioning mechanism to fix the support member.

2. The auxiliary moving device as claimed in claim 1, wherein the first cushion includes two first grooves located at two sides of a bottom end thereof respectively, and each support member matches with the first groove.

3. The auxiliary moving device as claimed in claim 2, further comprising a plurality of fixing elements connected with the bottom end of the first cushion, wherein the support member is retained between the fixing elements and the first cushion.

4. The auxiliary moving device as claimed in claim 1, wherein the first cushion includes two orifices which are located at the two sides of the bottom end of the first cushion, the support member inserts through the orifice.

5. The auxiliary moving device as claimed in claim 1, wherein when the post moves away the hole of the support member, the first cushion moves relative to the support member.

6. The auxiliary moving device as claimed in claim 1, wherein the positioning mechanism further includes a spring, and the post is inserted through the spring.

7. The auxiliary moving device as claimed in claim 6, wherein the positioning mechanism further includes a stopping piece, and the spring is defined between the stopping piece and a projection of the post.

8. The auxiliary moving device as claimed in claim 7, wherein when the first cushion moves on the support member, the projection of the post and the stopping piece press the spring so that the spring deforms.

9. The auxiliary moving device as claimed in claim 1 further comprising a second cushion disposed on the first cushion and a chair back fixed on one side of the second cushion.
